(19) United States
(12) Patent Application Publication
(10) Pub. No.: US 2026/0209469 A1
(43) Pub. Date: Jul. 23, 2026

(54) DIELECTRIC CURABLE COMPOSITION AND DIELECTRIC CURABLE COMPOSITION COMPONENT

(71) Applicant: 3M INNOVATIVE PROPERTIES COMPANY, St. Paul, MN (US)

(72) Inventors: Kolby L. White, Woodbury, MN (US); Timothy D. Fletcher, Lino Lakes, MN (US)

(21) Appl. No.: 19/143,179

(22) PCT Filed: Dec. 19, 2023
(86) PCT No.: PCT/IB2023/062933

§ 371 Date: Jun. 25, 2025

Related U.S. Application Data
(60) Provisional application No. 63/477,238, filed on Dec. 27, 2022.

(51) Int. Cl. C08K 3/22; C08G 59/42; C08G 59/50

(52) U.S. Cl. CPC C08K 3/22; C08G 59/4238; C08G 59/5026; C08G 59/504; C08K 2003/2237

(57) ABSTRACT

Curable composition components are described. In particular, curable composition components that include at least one of an epoxy or a curing agent, and 20 to 60 weight percent of barium titanate are described. Such curable composition components and related curable compositions may exhibit desirable dielectric properties while maintaining dispensability, and preserve their appearance through subsequent processing steps.

### FIELD

The present disclosure relates to curable compositions and curable composition components.

### BACKGROUND

The present disclosure relates to curable compositions and curable composition components. Such components and compositions have wide applicability in bonding and assembly applications.

### SUMMARY

In one aspect, the present description relates to a curable composition component. The curable composition component includes at least one of an epoxy or a curing agent, and 20 to 60 weight percent of barium titanate. The curable composition component has a viscosity of less than 30 Pa*s at 10 Hz and 25° C. The curable composition component is configured such that when it includes both an epoxy and a curing agent to form a curable composition, an overlap shear strength, after curing, of the curable composition on aluminum is greater than 25 MPa.

In another aspect, the present description relates to a curable composition. The curable composition includes both an epoxy and a nitrogen-containing curing agent, and 20 to 60 weight percent of barium titanate.

In yet another aspect, the present description relates to a method. The method includes providing a curable composition including both an epoxy and a nitrogen-containing curing agent, and 20 to 60 percent of barium titanate, and dispensing the composition.

In another aspect, the present description relates to a kit for a curable composition. The kit includes an A component, the A component including an epoxy and from at least 20 to 60 weight percent of barium titanate, wherein the A component has a viscosity of less than 30 Pa*s at 10 Hz and 25° C. The kit also includes a B component, where the B component includes a curing agent and from at least 20 to 60 weight percent of barium titanate, wherein the B component has a viscosity of less than 30 Pa*s at 10 Hz and 25° C. After combining the A component and the B component at a proportion of 1:2 to form a curable composition, an overlap shear strength, of the curable composition on aluminum is greater than 25 MPa.

### DETAILED DESCRIPTION

Curable compositions are useful in a wide range of applications. In some applications, curable compositions are used in electronic devices that are subject to a number of manual, semi-automated, or automated preparation and assembly steps. Among these steps may be processes requiring corrosive or reactive chemicals, significant irradiation, or large variations in temperature. Curable compositions that do not significantly change their properties or appearance after undergoing such processes may be particularly useful. As electronic devices include ever-increasing numbers of antennas, radios, and other wireless components, it may be increasingly important for the curable compositions to have a high dielectric constant and low dielectric loss. These properties may prevent the curable composition—which may be designed to preserve a gap within a metallic frame so radio waves can enter and/or exit—from interfering with or blocking signals.

While epoxy-based materials have high adhesion and good durability for bonding to materials such as metals, glass, ceramics, and plastics, conventional epoxy-based materials are not color stable, in that they yellow or darken significantly when exposed to heat, UV radiation, or chemicals. Certain epoxy-based materials, such as those described in PCT Publication WO 2022/053954 A2, may provide color stability. However, these materials are often used as replacements in existing designs using other materials. Therefore, for electronic device designs specifically optimized for specific electrical properties (e.g., dielectric constant, dielectric loss tangent), substitution of an epoxy-based material for a previous material may require substantial modification to that device design to preserve performance. For example, scratch resistant glass useful with electronic devices may exhibit a dielectric constant of approximately 5-7 over radio wavelengths of potential interest. By contrast, unmodified epoxy-based materials typically have a much lower dielectric constant over those same wavelengths: for example, between 2 and 4.

Dielectric properties (such as the dielectric constant) of a curable composition may be modified by adding a filler to the composition. However, the high fill level required to approximate the dielectric properties of glass may modify the rheological properties of the composition and make too viscous to be dispensed. Alternatively, the high fill levels required to approximate the dielectric properties of glass may reduce the adhesive strength of the composition, rendering it unsuitable for the purpose. Surprisingly, curable compositions and curable composition components filled with barium titanate required fill percentages that allowed glass-like dielectric properties while still maintaining good dispensability-useful in a high throughput manufacturing process-along with good adhesive performance. In other words, surprisingly, a set of adhesives has been found that behaves electrically similarly to glass while still retaining the desirable physical properties of a dispensable color-stable curable composition.

The terms “aliphatic” and “cycloaliphatic” as used herein refer to compounds with hydrocarbon groups that are alkyl or alkylene groups.

The term “alkyl” refers to a monovalent group that is a radical of an alkane, which is a saturated hydrocarbon. The alkyl can be linear, branched, cyclic, or combinations thereof and typically has 1 to 20 carbon atoms. In some embodiments, the alkyl group contains 1 to 18, 1 to 12, 1 to 10, 1 to 8, 1 to 6, or 1 to 4 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethylhexyl.

The term “alkylene” refers to a divalent group that is a radical of an alkane. The alkylene can be straight-chained, branched, cyclic, or combinations thereof. The alkylene often has 1 to 20 carbon atoms. In some embodiments, the alkylene contains 1 to 18, 1 to 12, 1 to 10, 1 to 8, 1 to 6, or 1 to 4 carbon atoms. The radical centers of the alkylene can be on the same carbon atom (i.e., an alkylidene) or on different carbon atoms.

The term “aromatic” as used herein refers to compounds with hydrocarbon groups that are aryl or arylene groups.

The term “non-aromatic” as used herein refers to compounds that do not include aryl or arylene groups.

The term “aryl” refers to a monovalent group that is aromatic and carbocyclic. The aryl can have one to five rings that are connected to or fused to the aromatic ring. The other ring structures can be aromatic, non-aromatic, or combinations thereof. Examples of aryl groups include, but are not limited to, phenyl, biphenyl, terphenyl, anthryl, naphthyl, acenaphthyl, anthraquinonyl, phenanthryl, anthracenyl, pyrenyl, perylenyl, and fluorenyl.

The term “arylene” refers to a divalent group that is carbocyclic and aromatic. The group has one to five rings that are connected, fused, or combinations thereof. The other rings can be aromatic, non-aromatic, or combinations thereof. In some embodiments, the arylene group has up to 5 rings, up to 4 rings, up to 3 rings, up to 2 rings, or one aromatic ring. For example, the arylene group can be phenylene.

Curable compositions described herein may be provided in two components mixed together (in, for example, a 1:1 volumetric or weight ratio, a 2:1 volumetric or weight ratio, a 1:2 volumetric or weight ratio, a 3:1 volumetric or weight ratio, a 1:3 volumetric or weight ratio) or any other suitable ratio or proportion) before dispensing (often referred to as a 2K system) or provided in a single component (often referred to as a 1K system). Because the characteristics described herein may be applicable for either of the components of a 2K system or for the single component of a 1K system, the description will refer to a curable composition or a curable composition component throughout, wherever appropriate. In some embodiments, it may be beneficial to match, as closely as practical, the physical properties of each of the components, so that they can be easily processed and mixed together.

In some embodiments, the curable composition or curable composition components may include at least one non-aromatic epoxy resin. Suitable non-aromatic epoxy resins include diglycidyl ether based epoxy resins and alicyclic epoxy resins such as diepoxy acetals, diepoxy adipates, diepoxy carboxylates, and dicyclopentadiene-based epoxy resins; isocyanurate derivative epoxy resins such as triglycidyl isocyanurate; and hydrogenated epoxy resins prepared by hydrogenating the aromatic ring(s) within aromatic epoxy resins such as bisphenol A epoxy resins, bisphenol F epoxy resins, phenol novolak epoxy resins, cresol novolak epoxy resins, naphthalene epoxy resins, biphenyl epoxy resins, aralkyl epoxy resins and biphenylaralkyl epoxy resins. Two or more of these resins may also be used in combination.

In some embodiments, the non-aromatic epoxy resins may be no color or low color and/or transparent resins. In this manner, the color of the curable compositions (or the color of the combined curable composition components) of the present description may be established primarily by the colorants included in the compositions.

In some embodiments, the non-aromatic epoxy resin is a liquid epoxy resin at room temperature. In some embodiments, the non-aromatic aromatic epoxy resin is the majority reactive component of the curable composition. In some embodiments, the curable composition comprises 50-95, 50-80, or 60-90 parts by weight of non-aromatic epoxy resin per 100 parts total weight of reactive components.

In some embodiments, the curable composition or curable composition component also comprises one or more anhydride-based curing agents. As used herein, an “anhydride-based curing agent” refers to a compound formed by dehydrating a dicarboxylic acid according to structural formula (I), where A is an aliphatic or cycloaliphatic linking group.

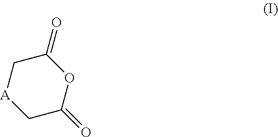

Examples of suitable anhydride-based curing agents include: linear polymeric anhydrides such as polysebacic and polyazelaic anhydride; alicyclic anhydrides such as methyltetrahydrophthalic anhydride, tetrahydro phthalic anhydride, methyl nadic anhydride, hexahydrophthalic anhydride, and methylhexahydrophthalic anhydride; simple alicylic anhydrides such as succinic anhydride, substituted succinic anhydride, citric acid anhydride, maleic anhydride and special adducts of maleic anhydride, dodecyl succinic anhydride, maleic anhydride, or multi-ring alicyclic anhydrides. In some embodiments, a combination of two or more anhydride-based curing agents may be used; for example, a combination of tetrahydro phthalic anhydride and citric acid anhydride, a combination of methylhexahydrophthalic anhydride and dodecyl succinic anhydride, or a combination of methyl nadic anhydride and maleic anhydride.

In some embodiments, the curable compositions or curable composition components comprise 10-45, 10-30, or 12-25 parts by weight of anhydride-based curing agent per 100 parts total weight of reactive components. In some embodiments, the curing agent consists of, or consists essentially of, anhydride-based curing agents.

In some embodiments, alternatively, the curing agents may include one or more amine-based curing agents. In some embodiments, the amine-based curing agents may be non-aromatic. Examples of suitable amine-based curing agents include: liquid polyetheramines such as the commercially available JEFFAMINE T-403 and JEFFAMINE D-230 from Huntsman Corp.; 4,7,10-Trioxatridecane-1,13-diamine, and 4,9-Dioxadodecane-1,12-diamine; polyamidoamines such as VERSAMID 125 and GENAMID 490 commercially available from BASF; ethyleneamines such as DETA (diethylene triamine), TETA (triethylenetetramine), TEPA (tetraethylenepentamine), and AEP (N-aminoethylpiperazine); cycloaliphatics such as PACM (bis-(p-aminocyclohexyl) methane), DACH (diaminocyclohexane), and DMCH (bis-(dimethyldi-aminocyclohexyl) methane); isophorone diamine, and norbornene dimethylamine.

In some embodiments, the curing agents may include no-color or low-color and/or transparent curing agents. In this manner, the color of the curable compositions (or the color of the combined curable composition components) of the present description may be established primarily by the colorants included in the compositions.

In some embodiments, the curing agent is a liquid at room temperature.

In some embodiments, the curable compositions comprise 10-35, 10-20, 18-30, or 12-18 parts by weight of amine-based curing agent per 100 parts total weight of reactive components.

In some embodiments, the curable compositions or the curable composition components of the present description may include one more colorants (or dyes or pigments). As used herein, the term “colorants” refers to a substance that is added to the composition for purposes of imparting color and/or other opacity to the compositions—the term “colorant” does not encompass the reactive components or any other materials added to the curable compositions to effect cure. For example, one or more colorants may be present in the curable composition or curable composition components such that the cured curable composition “color matches” the color of a component to which the cured composition will be adjacent (e.g., an external/user visible component of an electronic device). Various types of colorants may be suitable for the curable compositions including commercially available dyes for the azo (e.g, Oil Red O) and anthraquinone (e.g., Solvent Blue 35) family of colorants. In some embodiments, suitable colorants may include organic dyes such as azo, anthraquinoe, phthalocyanine blue and green, quinacridone, dioxazine, isoindolinone, or vat dyes. In some embodiments, the colorants include copper phthalocyanine (blue and green), azo, diarylide, quidacridone, isoindoline, diketo-pyrrole, indanthrone, carbon blacks, iron oxides, or titanium dioxides.

In some embodiments, the colorant may be dispersed or otherwise disposed in the curable compositions (as well as the cured compositions) such that the compositions have a uniform or substantially uniform color throughout their composition at a wide range of operating temperatures (e.g., between-40 and 85 degrees Celsius). In some embodiments, the colorant may be stable in the curable compositions (i.e., (i) non-reactive or substantially non-reactive with or not consumed by the components of the curable composition or curable composition compoments; and (ii) remain uniformly or substantially uniformly dispersed at a wide range of operating temperatures over extended periods).

In some embodiments, colorants may be present in the curable compositions or the curable composition components in an amount of between 0.1 and 10 wt. % or between 0.1 and 5 wt. %, based on the total weight of the reactive components.

The curable composition may contain additional optional additives. These optional additives can be either solids or liquids, and reactive or unreactive. Among the suitable additives are fillers, including thermally conductive fillers, flame retardants (such as ATH (aluminum trihydrate) or phosphate flame retardants), nanoparticles or functionalized nanoparticles, chain extenders, toughening agents, or combinations thereof. These components are typically solids, but some of the additive components can be liquids.

Examples of non-reactive additives include fillers, flame retardants, nanoparticles, and toughening agents. Suitable non-reactive additives are fillers such as metal oxides (silica, titania, magnesium oxide, and the like) and thermal conductivity enhancers such as boron nitride. In some embodiments, dielectric fillers such as barium titanate that increases the dielectric constant of the curable composition, curable composition component, or the cured composition. In some embodiments, the curable compositions or curable composition components may be highly filled; for example, 50 weight percent, or 30-50 weight percent, or 20-60 weight percent of the curable composition or curable composition component may be a filler (such as silica or titania or barium titanate). In some embodiments, these fillers may be selected for their geometry and rheology. In some embodiments, these fillers may have substantially spherical shape. In some embodiments, the size and distribution of these fillers may be selected for optimal or desired flowability characteristics. In some embodiments, the fillers may have a bimodal size distribution. In some embodiments, the fillers include at least two populations of particle sizes: one larger than 3 micrometers and one smaller than 3 micrometers.

In some embodiments, additives for the curable compositions (or curable composition components) of the present description may include one or more epoxy toughening agents. Such toughening agents may be useful, for example, for improving certain properties of the compositions so that they do not undergo brittle failure in a fracture. Examples of useful toughening agents, which may also be referred to as elastomeric modifiers, include polymeric compounds having both a rubbery phase and a thermoplastic phase such as graft copolymers having a polymerized diene rubbery core and a polyacrylate or polymethacrylate shell; graft copolymers having a rubbery core with a polyacrylate or polymethacrylate shell; elastomeric particles polymerized in situ in the epoxide from free-radical polymerizable monomers and a copolymeric stabilizer; elastomer molecules such as polyurethanes and thermoplastic elastomers; separate elastomer precursor molecules; combination molecules that include epoxy-resin segments and elastomeric segments; and, mixtures of such separate and combination molecules. The combination molecules may be prepared by reacting epoxy resin materials with elastomeric segments; the reaction leaving reactive functional groups, such as unreacted epoxy groups, on the reaction product. The use of tougheners in epoxy resins is described in the Advances in Chemistry Series No. 208 entitled “Rubbery-Modified Thermoset Resins”, edited by C. K. Riew and J. K. Gillham, American Chemical Society, Washington, 1984. The amount of toughening agent to be used depends in part upon the final physical characteristics of the cured resin desired.

In some embodiments, the toughening agent in the curable compositions (or the curable composition components) of the present description may include graft copolymers having a polymerized diene rubbery backbone or core to which is grafted a shell of an acrylic acid ester or methacrylic acid ester, monovinyl aromatic hydrocarbon, or a mixture thereof, such as those disclosed in U.S. Pat. No. 3,496,250 (Czerwinski). Rubbery backbones can comprise polymerized butadiene or a polymerized mixture of butadiene and styrene. Shells comprising polymerized methacrylic acid esters can be lower alkyl (C₁₋₄) methacrylates. Monovinyl aromatic hydrocarbons can be styrene, alpha-methylstyrene, vinyltoluene, vinylxylene, ethylvinylbenzene, isopropylstyrene, chlorostyrene, dichlorostyrene, and ethylchlorostyrene.

Further examples of useful toughening agents are acrylate core-shell graft copolymers wherein the core or backbone is a polyacrylate polymer having a glass transition temperature (T_{g}) below about 0° C., such as poly (butyl acrylate) or poly (isooctyl acrylate) to which is grafted a polymethacrylate polymer shell having a T_{g} about 25° C. such as poly(methyl methacrylate). For acrylic core/shell materials “core” will be understood to be acrylic polymer having T_{g}<0° C. and “shell” will be understood to be an acrylic polymer having T_{g}>25° C. Some core/shell toughening agents (e.g., including acrylic core/shell materials and methacrylate-butadiene-styrene (MBS) copolymers wherein the core is crosslinked styrene/butadiene rubber and the shell is polymethylacrylate) are commercially available, for example, from Dow Chemical Company under the trade designation “PARALOID”.

Another useful core-shell rubber is described in U.S. Pat. Appl. Publ. No. 2007/0027233 (Yamaguchi et al.). Core-shell rubber particles as described in this document include a cross-linked rubber core, in most cases being a cross-linked copolymer of butadiene, and a shell which is preferably a copolymer of styrene, methyl methacrylate, glycidyl methacrylate and optionally acrylonitrile. Specific examples are Kane Ace M731, M732, M511, and M300 commercially available from Kaneka.

In some embodiments, the toughening agent may include an acrylic core/shell polymer; a styrene-butadiene/methacrylate core/shell polymer; a polyether polymer, a carboxyl- or amino-terminated acrylonitrile/butadiene; a carboxylated butadiene, a polyurethane, or a combination thereof.

In some embodiments, toughening agents may be present in the curable composition in an amount between 0.1 and 10 wt. %, 0.1 and 5 wt. %, 0.5 and 5 wt. %, 1 and 5 wt. %, or 1 and 3 wt. %, based on the total weight of the curable composition or the curable composition component.

In some embodiments, the curable composition or curable composition component includes a catalyst. In some embodiments the catalyst is a nitrogen-containing catalyst. In some embodiments, the nitrogen-containing catalyst is solid at room temperature, or at temperatures below 25° C. Suitable solid nitrogen-containing catalysts include FUJICURE FXR-1081 (available from T&K Toka Corporation, Saitama, Japan), Ancamine 2441 (available from Evonik Industries AG, Essen, Germany), and Ancamine 2442 (available from Evonik Industries AG, Essen, Germany).

In some embodiments, upon curing, the curable compositions of the present description may exhibit thermal, mechanical, and rheological properties that render the compositions particularly useful as adhesives or coatings for cosmetic applications that require strong adhesion to substrates over time as well as strong adhesion to substrates upon sudden impact (i.e., strong drop performance). In some embodiments, in addition to having strong adhesion, durability, drop performance, the curable compositions of the present description may exhibit color stability in the presence of heat, UV light, and household chemicals, as well as when exposed to chemical anodization or dye infusion processes. In this regard, in some embodiments, upon exposure to an acid bath in accordance with the Anodization Bath Simulation Process set forth in the Examples of the present description, the cured compositions of the present description may exhibit a ΔE 94 color change of less than 1, less than 0.8, or less than 0.5. In some embodiments, upon exposure to an ultraviolet light in accordance with the UV exposure tests set forth in the Examples of the present description, the cured compositions of the present description may exhibit a ΔE 94 color change of less than 5, less than 3, less than 2, or less than 1.

In some embodiments, the cured compositions exhibit performance properties requisite of an adhesive suitable for use in electronic devices. In this regard, in some embodiments, the cured compositions may have an overlap shear value on an etched aluminum substrate of at least 25 MPa, at least 30 MPa, or at least 35 MPa. For purposes of the present description, overlap shear values are determined in accordance with ASTM D-1002-72. Further, the cured compositions may have a notched izod toughness value of at least 20 J/m, at least 30 J/m, or at least 40 J/m. For purposes of the present description, notched izod toughness values are determined in accordance with ASTM D-256.

In some embodiments, the cured compositions may have a tensile elongation of at least 10% and a glass transition temperature of at least 80 degrees Celsius.

Also disclosed herein are articles prepared from the curable compositions described above.

In some embodiments, the articles of the present description may be fabricated by forming the curable compositions (or curable composition components, after combination) (before, after, or during cure) into a desirable or predetermined shape. Shaping of the curable compositions (or cured compositions) may be carried out using machining, micromachining, microreplication, molding, extruding injection molding, ceramic pressing, or the like. In this manner, articles of any size or shape may be formed using the curable compositions of the present description. For example, in some embodiments, the articles of the present description may include user visible, or cosmetic, components of an electronic device (e.g., a case or housing for a mobile phone, tablet, watch, headphone, or laptop).

In further embodiments, the curable compositions (or cured composition components, after combination) may be coated onto a substrate and permitted to cure. The articles may include a substrate comprising a first major surface and a second major surface, and a coating on at least a portion of the second major surface of the substrate, where the coating comprises a cured layer of a curable composition.

The coatings can be coated on a wide range of substrates. Examples of suitable substrates include metal substrates, ceramic substrates, glass substrates, or polymeric substrates. The substrates can be in a variety of shapes such as plates or tubes, and may have smooth or irregular surfaces and may be hollow or solid.

The curable composition (or cured composition components, after combination) can be applied to a substrate to form a curable layer using a variety of techniques, including dip coating, forward and reverse roll coating, wire wound rod coating, and die coating. Die coaters include knife coaters, slot coaters, slide coaters, fluid bearing coaters, slide curtain coaters, and drop die curtain coaters. Upon coating, the curable composition is permitted to cure to form a cured coating.

The thickness of the coating varies depending upon the desired use for the coating. In some embodiments, the coatings may range from 25 micrometers (1 mil) to 1 millimeter in thickness. The curable compositions may be coated onto substrates at useful thicknesses ranging from 5 microns to 10000 microns, 25 micrometers to 10000 micrometers, 100 micrometers to 5000 micrometers, or 250 micrometers to 1000 micrometers.

In some embodiments, the curable composition (or cured composition components, after combination) may function as a structural adhesive, i.e. the curable composition is capable of bonding a first substrate to a second substrate, after curing. In some embodiments, the present description provides an article comprising a first substrate, a second substrate, and a cured composition disposed between and adhering the first substrate to the second substrate, wherein the cured composition is the reaction product of the curable composition according to any one of the curable compositions (or combinations of cured composition components) of the present description. In some embodiments, the first and/or second substrate may be at least one of a metal, a ceramic, and a polymer.

The curable compositions (or curable composition components, after combination) may be coated onto substrates at useful thicknesses ranging from 5 micrometers to 10000 micrometers, 25 micrometers to 10000 micrometers, 100 micrometers to 5000 micrometers, or 250 micrometers to 1000 micrometers. Useful substrates can be of any nature and composition, and can be inorganic or organic. Representative examples of useful substrates include ceramics, siliceous substrates including glass, metal (e.g., aluminum or steel), natural and man-made stone, woven and nonwoven articles, polymeric materials, including thermoplastic and thermosets, (such as polymethyl (meth)acrylate, polycarbonate, polystyrene, styrene copolymers, such as styrene acrylonitrile copolymers, polyesters, polyethylene terephthalate), silicones, paints (such as those based on acrylic resins), powder coatings (such as polyurethane or hybrid powder coatings), and wood; and composites of the foregoing materials.

In some embodiments, the curable compositions (or combination of curable composition components) of the present description may be used as a cosmetic inlay for an electronic device or component of an electronic device. Generally, a cosmetic inlay refers to a component that is positioned within a gap or hole in another material, and that is positioned, sized, and shaped such that it fills (or substantially fills) the gap or hole and is flush (or substantially flush) with the material adjacent the component/inlay. In some embodiments, the curable compositions may be used a cosmetic inlay for the casing or housing or an electronic device (mobile phone, tablet, or laptop). The casing or housing may be formed of metal (e.g, aluminum).

### EXAMPLES

TABLE 1
Materials

| Material | Description | Source |
|---|---|---|
| YX8000D | Phenol, 4,4′-(1-methylethylidene)bis-, | Mitsubishi |
| | polymer with 2-(chloromethyl)oxirane, | Chemicals, |
| | hydrogenated obtained under the | Tokyo Japan |
| | trade designation jER | |
| | YX8000D | |
| MX257 | Liquid impact modifier | Kaneka, |
| | based on bisphenol-A | Tokyo Japan |
| | epoxy | |
| Epon 828 | BPA Epoxy solution | Hexion Inc., |
| | obtained under the trade | Columbus, |
| | designation EPON 828 | OH |
| Byk 9010 | Wetting and dispersing | Byk, Singen, |
| | additive for filled unsaturated | Germany |
| | polyester systems and | |
| | epoxy systems | |
| H21 | Pyrogenic silica, obtained | Wacker |
| | under the trade | Chemie AG, |
| | designation HDK H21 | Munich, |
| | | Germany |
| 219-6A | Barium Titanate Filler | Ferro, Mayfield |
| | | Heights, OH |
| Epon 58005 | EPON ™ Resin 58005 is | Hexion Inc., |
| | an elastomer modified | Columbus, |
| | epoxy functional adduct | OH |
| | formed from the | |
| | reaction of the diglycidyl | |
| | ether of bisphenol A | |
| | and a carboxyl terminated | |
| | butadiene-acrylonitrile | |
| | elastomer. | |
| MX154 | Liquid impact modifier | Kaneka, Tokyo |
| | based on bisphenol-A | Japan |
| | epoxy | |
| FXR-1081 | A latent epoxy curing | T&K Toka |
| | agent and curing | Corporation, |
| | accelerator, available | Saitama, |
| | under the tradename | Japan |
| | FUJICURE FXR-1081 | |
| Lindride | Methylhexahydrophthalic | Lindau |
| 52-D | anhydride, obtained | Chemicals, Inc., |
| | under the trade designation | Columbia, |
| | Lindride 52-D | SC, United |
| | | States |
| DDSA | Dodecenylsuccinic anhydride | Dixie Chemical |
| | | Company, Inc., |
| | | Pasadena, |
| | | TX, United |
| | | States |
| Irganox | Thiodiethylene bis[3- | BASF |
| 1035 | (3,5-di-tert-butyl-4- | Corporation, |
| | hydroxyphenyl)propionate], | Florham |
| | available under the | Park, NJ, |
| | tradename Irganox 1035 | United States |
| PACM | Cycloaliphatic diamine, | Evonik, Essen, |
| | available under the | Germany |
| | tradename Vestamin PACM | |
| TTD | 4,7,10-Trioxatridecane- | BASF, |
| | 1,13-Diamine | Ludwigshafen, |
| | | Germany |

### Test Methods

### Sample Preparation for Dielectric, Color, and Anodization Exposure Testing.

Curable mixtures were coated between polyester release liners at approximately 1.6 mm thickness. The coated films cured for at least 1 hour at 120° C. and cooled to room temperature before they were cut into plaques used for testing.

### Color Change Test Method

The color change of the plaques was measured as follows. Initial color was measured for each plaque using a Konica CM3700A spectrophotometer (available from Konica Minolta Sensing Americas, Inc. Ramsey, New Jersey), in reflectance specular component included (SCI) mode with a 10-degree observer angle. After a plaque was exposed to the Anodization Bath Simulation Process, the color was measured again. The difference in color before and after the acid bath exposure was calculated using the ΔE 94 calculation as designated by the International Commission on Illumination (CIE) with an 1:C ratio of 2:1 under the illuminants F02 (cool white fluorescent). A ΔE 94 color change of less than 1 is generally regarded as undetectable to the human eye.

### Preparation of Acid Baths to Simulate Anodization Process

Suitable anodization processes for electronic devices made with aluminum are described in US Patent Publication No. 2013/0270120 A1. The process steps having the greatest impact on adhesive color are de-smut and chemical polish. A de-smut bath was made using 30% nitric acid. A chemical polish bath was made using 85% phosphoric acid.

### Anodization Bath Simulation Process

The Example and Comparative Example plaques were individually immersed in the de-smut bath for 180 seconds at 25° C.; this was immediately followed by a 30 second rinse in deionized water. Next, the plaques were immersed for 180 seconds in the chemical polish bath which had been pre-heated to 80° C. This was followed by rinsing in deionized water for 60 seconds. The plaques were then allowed to dry at ambient conditions before final color measurement.

### Tensile Strength, Modulus and Elongation Test Method

Curable mixtures were coated between polyester release liners at approximately 0.5 mm thickness. The coated films cured for at least 1 hour at 120° C. and cooled to room temperature before testing. Test samples were cut from the cured films using a TYPE-IV die as specified in ASTM Standard D638-14 “Standard Test Method for Tensile Properties of Plastics”. The samples were tested to failure in uniaxial tension at a rate of 100 mm/min using a tensile load frame with pneumatically tightened grips (MTS Systems, Eden Prairie, MN). The tensile modulus value was taken as the initial liner slope of the stress vs strain curve and elongation was taken as the strain at break expressed as a percentage of the initial gauge length of the sample and the displacement of the crosshead during testing. Tensile Strength at break was also measured. The average of five individual test samples is reported.

### Overlap Shear Test Method

The performance of adhesives was determined using overlap shear tests. Aluminum coupons were etched before use. The mixture was then applied to a 1″×0.5″ area on one end of the aluminum coupon, and 3-5 mil spacer beads were employed to control bond line thickness. One end of a second aluminum coupon was then pressed into to the mixture to produce an overlap of approximately 0.5″. A binder clip was placed on the sample, and it was cured for at least 1 hour at 120° C. and cooled to room temperature before testing. The samples were tested to failure in uniaxial tension at a rate of 0.1 in/min using a tensile load frame with Advantage Wedge Action Grips (MTS Systems, Eden Prairie, MN). The single lap shear strength was taken as the peak force recorded during testing divided by the overlap area of the two coupons. The average of five individually prepared samples is reported.

### Viscosity Test Method

The viscosity of the Part A and Part B was measured by a shear rate sweep using a Discovery HR-3 Rheometer (commercially available from TA Instruments, New Castle, DE) in the cone and plate mode of operation, and in accordance with ASTM D3795-20. The measurements were taken at 25° C. (77° F.) using a 40 millimeters (mm) diameter stainless steel cone with a cone angle of 0.03499 radians and a 60 mm plate. Two to three grams of curable resin composition were placed between the cone and plate. The cone and plate were then closed to provide a 0.051 mm gap (at the tip) filled with resin. Excess resin was scraped off the edges with a spatula. Viscosity was measured using a shear rate sweep from 0.01 to 100 Hertz and the viscosity at 10 Hz is reported.

### Dielectric Test Method

All split-post dielectric resonator measurements were performed in accordance with the standard IEC 61189-2-721, at the individual frequencies. Each material was inserted between two fixed dielectric resonators. The resonance frequency and quality factor of the posts are influenced by the presence of the specimen, and this enables the direct computation of complex permittivity (dielectric constant and dielectric loss). The geometry of the split dielectric resonator fixture used in our measurements was designed by the Company QWED in Warsaw Poland. These resonators operate with the TEold mode which has only an azimuthal electric field component so that the electric field remains continuous on the dielectric interfaces. The split post dielectric resonator measures the permittivity component in the plane of the specimen. Loop coupling (critically coupled) was used in each of these dielectric resonator measurements. This Split Post Resonator measurement system was combined with Keysight VNA (Vector Network Analyzer Model PNA N5222B along with millimeter-wave test set model N5292A, 900 Hz-110 GHz). Computations were performed with the commercial analysis Split Post Resonator Software of QWED to provide a powerful measurement tool for the determination of complex electric permittivity of each specimen at the specific frequency.

### Free-Space Quasi-Optical Bench 60 GHZ

The quasi-optical bench is from Thomas Keating-Instruments™ and includes input+output horn antennas, diffraction-limited folding mirrors, and a 150 mm aperture sample holder. The quasi-optical system was combined with Keysight VNA (Vector Network Analyzer Model PNA N5222B along with millimeter-wave test set model N5292A, 900 Hz-110 GHz).

Estimated Permittivity for in-Between Frequencies

Real part of the permittivity (8′) at frequencies not done using Split Post Dielectric Resonators or Quasi-Optical Bench, were estimated using the Lynch Formula (NIST Technical Note 1536 page 37):

$$\frac{\vert {ε}_{1} - {ε}_{2} \vert}{{ε}_{1}} = 1.5 * tan ( δ ) * log ( \frac{{f}_{2}}{{f}_{1}} )$$

$$Where ε = real part of permittivity ( ε ’ )$$

$$f = frequency ( GHz )$$

$$tan ( δ ) = ε ” / ε ’$$

Loss Tangent was estimated with least squares fit and then the imaginary part of permittivity (ε″) was calculated by multiplying the estimated ε′ and tan(δ)

$$ε ’ * tan ( δ ) = ε ”$$

### EXAMPLES

TABLE 2
Example 1 Composition

| | | Lindride | | Epon | FXR- | 219- | Irganox |
|---|---|---|---|---|---|---|---|
| | YX8000D | 52-D | DDSA | 58005 | 1081 | 6A | 1035 |
| Ex. | 7 | 9 | 9 | 21 | 3.5 | 49.5 | 1 |
| 1 | | | | | | | |

TABLE 3
Color measurement of cured composition Example 1 before and
after anodization treatment

| Ex. 1 | L* | a* | b* | C* | h° | dE94 |
|---|---|---|---|---|---|---|
| Before Anodization | 95.06 | −0.25 | 3.42 | 3.43 | 94.13 | — |
| After Anodization | 94.92 | −0.21 | 3.9 | 3.9 | 93.11 | 0.44 |

TABLE 4
Example 1 Adhesive properties

| | | | Dielectric | Dielectric |
|---|---|---|---|---|
| | | | Constant | Loss |
| | OLS | | @ 2.5 | @ 2.5 |
| | (MPa) | Tg (° C.) | GHz, | GHz |
| Ex. 1 | 17.5 | 80 | 5.75 | 0.022 |

TABLE 5
Example 2 to 6 and Comparative Example 1 to 2 Part A
Formulations (wt %)

| | Epon 828 | MX154 | TTD | PACM | 219-6A | H21 |
|---|---|---|---|---|---|---|
| Ex. 2 Part A | 5.9% | 11.8% | 16.2% | 27.0% | 38.2% | 1.0% |
| Ex. 3 Part A | 5.6% | 11.1% | 15.2% | 25.3% | 42.0% | 0.8% |
| Ex. 4 Part A | 5.3% | 10.5% | 14.4% | 24.0% | 45.1% | 0.8% |
| Ex. 5 Part A | 4.9% | 9.7% | 13.3% | 22.2% | 49.3% | 0.7% |
| Ex. 6 Part A | 4.7% | 9.3% | 12.8% | 21.4% | 51.8% | — |
| CEx. 1 Part A | 3.1% | 6.2% | 8.5% | 14.2% | 68.0% | — |
| CEx. 2 Part A | 2.0% | 3.9% | 5.5% | 9.2% | 79.4% | — |

TABLE 6
Example 2 to 6 and Comparative Example 1 to
2 Part B Formulations (wt %)

| | | | Byk | | |
|---|---|---|---|---|---|
| | YX8000D | MX257 | 9010 | 219-6A | H21 |
| Ex. 2 | 39.2% | 22.4% | 0.1% | 36.7% | 1.6% |
| Part B | | | | | |
| Ex. 3 | 35.8% | 20.4% | 0.1% | 42.4% | 1.3% |
| Part B | | | | | |
| Ex. 4 | 33.9% | 19.4% | 0.1% | 45.4% | 1.3% |
| Part B | | | | | |
| Ex. 5 | 31.6% | 18.0% | — | 49.2% | 1.2% |
| Part B | | | | | |
| Ex. 6 | 28.8% | 16.4% | — | 53.8% | 1.0% |
| Part B | | | | | |
| CEx. 1 | 20.1% | 11.4% | — | 68.5% | — |
| Part B | | | | | |
| CEx. 2 | 17.4% | 5.6% | — | 77.0% | — |
| Part B | | | | | |

### Example 2 to 6 and Comparative Example 1 to 2 (Part A and B) Mixing Procedure

Curable adhesives were combined following the compositions in Table 5 and 6. Each component of Part A or Part B were added to a plastic cup and mixed for 1 to 5 minutes using a speed mixer (Dac 400 from Flack-tek, Landrun, SC). Then, in a new plastic cup, in a 2 to 1 volumetric ratio (B to A) the two materials were each added to a plastic cup and mixed for 1 to 5 minutes using a speed mixer (Dac 400 from Flack-tek, Landrun, SC).

TABLE 7
Example 2 to 5 Adhesive Properties

| | Tensile | | | OLS | | Constant | Dielectric |
|---|---|---|---|---|---|---|---|
| | Strength | Tensile | Modulus | (Mpa) | Viscosity at a | Dielectric @ 2.5 | Loss @ |
| | (Mpa) | Elongation | (Gpa) | 6061 Al | 10 Hz (Pa*s) | GHz | 2.5 GHz |
| Ex. 2 | 46.3 | 4.9 | 2.7 | 32 | 25 (Part A) | 4.59 | 0.0302 |
| (Part A and B) | | | | | 23 (Part B) | | |
| Ex. 3 | 45 | 6.0 | 2.3 | 32 | 25 (Part A) | 4.85 | 0.0332 |
| (Part A and B) | | | | | 23 (Part B) | | |
| Ex. 4 | 47 | 5.9 | 2.5 | 29 | 21 (Part A) | 5.21 | 0.0332 |
| (Part A and B) | | | | | 24 (Part B) | | |
| Ex. 5 | 47 | 6.7 | 2.6 | 29 | 29 (Part A) | 5.73 | 0.0358 |
| (Part A and B) | | | | | 24 (Part B) | | |

TABLE 8
Example 6 and Comparative Example 1 to 2 (Part A and B)
Adhesive Properties

| | | | | Dielectric | |
|---|---|---|---|---|---|
| | Tensile | | OLS | Constant | Dielectric |
| | Strength | Tensile | (Mpa) | @, 2.5 | Loss @ |
| | (Mpa) | Elongation | 6061 A1 | GHz | 2.5 GHz |
| Ex. 6 | 47 | 9.9 | 31 | 6.27 | 0.0338 |
| (Part A and B) | | | | | |
| CEx. 1 | 51 | 6.3 | 21 | 9.49 | 0.0360 |
| (Part A and B) | | | | | |
| CEx. 2 | 49 | 4.4 | 16 | 14.4 | 0.0409 |
| (Part A and B) | | | | | |

TABLE 9
Dielectric measurements on Example 5 (Part A and B)

| | Frequency [GHz] | ε′ | tan(delta) |
|---|---|---|---|
| Modeled | 0.6 | 5.81 | 0.0352 |
| Modeled | 1 | 5.75 | 0.0354 |
| SPDR | 1.1 | 5.73 | 0.0355 |
| Modeled | 1.7 | 5.68 | 0.0357 |
| Modeled | 2.4 | 5.74 | 0.0358 |
| SPDR | 2.47 | 5.73 | 0.0358 |
| Modeled | 3.6 | 5.69 | 0.0356 |
| Modeled | 4.4 | 5.67 | 0.0352 |
| SPDR | 5.18 | 5.65 | 0.0346 |
| Modeled | 5.8 | 5.64 | 0.0339 |
| SPDR | 10.11 | 5.57 | 0.0273 |
| SPDR | 15.23 | 5.44 | 0.0225 |
| SPDR | 24.71 | 5.44 | 0.0155 |
| Modeled | 39 | 5.39 | 0.0184 |
| QOB | 60 | 5.27 | (unreliable) |

These electrical and physical measurements demonstrate color-stable curable adhesive with a suitably high dielectric constant to act as an acceptable drop-in replacement for certain glass materials. The viscosity and adhesive performance (as demonstrated through the overlap shear test) are suitable for a wide variety of applications and can provide a reasonable design window for current and future electronic devices.

Various modifications and alterations of this invention will become apparent to those skilled in the art without departing from the scope and spirit of this invention.

What is claimed is:

1. A curable composition component, comprising:
at least one of an epoxy or a curing agent; and
20 to 60 weight percent of barium titanate;
wherein the curable composition component has a viscosity of less than 30 Pa*s at 10 Hz and 25° C.;
wherein the curable composition component is configured such that when it includes both an epoxy and a curing agent to form a curable composition, an overlap shear strength, after curing, of the curable composition on aluminum is greater than 25 MPa.

2. The curable composition component of claim 1, further comprising a core-shell toughening agent.

3. The curable composition component of claim 1, wherein the curing agent is one of an anhydride curing agent or an amine curing agent.

4. The curable composition component of claim 1, further comprising a colorant.

5. The curable composition component of claim 1, further comprising a dispersant.

6. The curable composition component of claim 1, further comprising a thixotrope.

7. A curable composition, comprising the curable composition component of claim 1, wherein the curable composition includes both an epoxy and a curing agent, and wherein an overlap shear strength, after curing, of the curable composition on aluminum is greater than 25 MPa.

8. A method, comprising:
providing a curable composition of claim 7; and
dispensing the composition.

9. The method of claim 8, further comprising curing the composition.

10. The method of claim 8, wherein curing the composition includes thermally curing the composition.

11. The method of claim 8, wherein curing the composition includes curing the composition with light.

12. A kit for a curable composition, comprising:
an A component, the A component including an epoxy and from at least 20 to 60 weight percent of barium titanate, wherein the A component has a viscosity of less than 30 Pas at 10 Hz and 25° C.;
a B component, the B component including a curing agent and from at least 20 to 60 weight percent of barium titanate, wherein the B component has a viscosity of less than 30 Pa*s at 10 Hz and 25° C.;
and wherein, after combining the A component and the B component at a proportion of 1:2 to form a curable composition, an overlap shear strength, after curing, of the curable composition on aluminum is greater than 25 MPa.

13. The kit of claim 12, wherein at least one of the A component and the B component further comprises a core-shell toughening agent.

14. The kit of claim 12, wherein the curing agent is one of an anhydride curing agent or an amine curing agent.

15. The kit of claim 12, wherein at least one of the A component and the B component further comprises a colorant.

16. The kit of claim 12, wherein at least one of the A component and the B component further comprises a dispersant.

17. The kit of claim 12, wherein at least one of the A component and the B component further comprises a thixotrope.
